(19) United States
(12) Patent Application Publication
(10) Pub. No.: US 2026/0126315 A1
(43) Pub. Date: May 7, 2026

(54) DETERMINING AND USING A MASS FLOW RATE ERROR CORRECTION RELATIONSHIP IN A VIBRATORY TYPE FLOW METER

(71) Applicant: MICRO MOTION, INC., Boulder, CO (US)

(72) Inventors: David KUHNY, Longmont, CO (US); Andrew Timothy PATTEN, Gunnison, CO (US); Marc Allan BUTTLER, Erie, CO (US)

(73) Assignee: MICRO MOTION, INC., Boulder, CO (US)

(21) Appl. No.: 19/117,482

(22) PCT Filed: Nov. 11, 2022
(86) PCT No.: PCT/US2022/049669

§ 371 Date: Apr. 1, 2025

Related U.S. Application Data
(60) Provisional application No. 63/417,058, filed on Oct. 18, 2022.

(51) Int. Cl. G01F 1/84; G01F 25/10

(52) U.S. Cl. CPC G01F 1/8436; G01F 1/8431; G01F 25/15

(57) ABSTRACT

A method for determining a mass flow rate error correction relationship is provided. The method includes comparing each of the plurality of mass flow rate measurements of a substitute gas flow with a corresponding each of a plurality of reference mass flow rate measurements of the substitute gas flow. The method also includes determining, based on the comparisons, a plurality of mass flow rate measurement errors corresponding to a plurality of fluid velocity-related parameter values of the substitute gas flow.

### TECHNICAL FIELD

The embodiments described below relate to correcting mass flow rate of a vibratory meter and, more particularly, to determining and using a mass flow rate error correction relationship for the vibratory meter.

### BACKGROUND

Vibratory meters, such as for example, Coriolis mass flowmeters, liquid density meters, gas density meters, liquid viscosity meters, gas/liquid specific gravity meters, gas/liquid relative density meters, and gas molecular weight meters, are generally known and are used for measuring properties of fluids. Generally, vibratory meters comprise a sensor assembly and a meter electronics. The material within or about the sensor assembly may be flowing or stationary. The vibratory meter may be used to measure a mass flow rate, density, or other properties of a material in the sensor assembly.

For example, Coriolis flow meters can measure a mass flow rate. By way of illustration the Coriolis flow meter may provide a drive signal to a driver that is disposed between two parallel and balanced conduits containing a fluid flowing through the conduits. The driver induces an out of phase vibration between the two conduits. The fluid flowing through the two conduits induces a phase difference of the inlets and outlets of the two conduits. This phase difference is measured by two pickoff sensors that are positioned on either side of a midpoint of the two conduits. For example, one pickoff may be proximate the inlets of the two conduits and another of the two pickoffs may be proximate the outlets of the two conduits. The measured phase difference is scaled by a flow calibration factor to obtain a mass flow rate measurement value. When gas is measured, the mass flow rate measurement value typically includes an error, which may be referred to as a mass flow rate measurement error, that is correlated with a mass flow rate of the gas.

Accordingly, calibration of Coriolis flow meters intended for measuring gas flows typically include determining mass flow rate measurement errors on a mass flow rate basis. For example, a reference Coriolis flow meter in line with a Coriolis flow meter being calibrated may provide a known mass flow rate measurement value of the gas flow. The known mass flow rate measurement value of the gas flow may be compared to an uncorrected mass flow rate measurement provided by the Coriolis flow meter being calibrated to determine a mass flow rate measurement error. This comparison to determine the mass flow rate measurement error may be performed at various mass flow rates of the gas flow to obtain pairs (e.g., ordered pairs) of mass flow rate measurement error values and mass flow rate values. The pairs may be used to correct a subsequent uncorrected mass flow rate measurement value obtained by the Coriolis flow meter.

As can be appreciated, a process gas may not be available for calibrating the Coriolis flow meter. Accordingly, substitute gases have been used to calibrate Coriolis flow meters. The substitute gases typically have densities that are different than a density of the process gas. This difference in density can cause deviations between mass flow rate measurement errors between different gases at a given flow rate. To reduce the density effects on mass flow rate measurement errors, a pressure of the substitute gas is adjusted until a density of the substitute gas is about the same as a density of the process gas whose mass flow rate measurement values are to be corrected.

However, a property or properties other than density can cause deviations between a mass flow rate measurement error of the substitute gas flow and the process gas flow. As a result, if the deviations are significant enough, the mass flow rate measurement errors of a substitute gas flow may not necessarily be transferrable to correct mass flow rate measurement errors of a process gas flow. Accordingly, there is a need for determining and using a mass flow rate error correction relationship for a vibratory meter.

### SUMMARY

A method of determining a mass flow rate error correction value for a vibratory meter is provided. According to an embodiment, the method comprises comparing each of a plurality of mass flow rate measurements of a substitute gas flow with a corresponding each of a plurality of reference mass flow rate measurements of the substitute gas flow, and determining, based on the comparisons, a plurality of mass flow rate measurement errors corresponding to a plurality of fluid velocity-related parameter values of the substitute gas flow.

A system for determining a mass flow rate error correction relationship for a vibratory meter is provided. According to an embodiment, the system comprises the vibratory meter configured to measure a mass flow rate of a substitute gas flow, a reference device in line with the vibratory meter, the reference device being configured to determine a reference mass flow rate of the substitute gas flow, and a calibration circuit in communication with the vibratory meter and the reference device, the calibration circuit being configured to perform the foregoing methods.

A method for using a mass flow rate error correction relationship for a vibratory meter is provided. According to an embodiment, the method comprises determining a fluid velocity-related parameter value of a process gas flow based on a measured mass flow rate value, a density value, and a cross-sectional area of the process gas flow and determining a mass flow rate error correction value based on the fluid velocity-related parameter value.

A meter electronics for using a mass flow rate error correction relationship is provided. According to an embodiment, the meter electronics comprises a storage system and a processing system communicatively coupled to the storage system, the processing system being configured to execute the foregoing methods.

A vibratory meter for using a mass flow rate error correction relationship is provided. According to an embodiment, the vibratory meter comprises a sensor assembly configured to measure a mass flow rate of a process gas flow and a meter electronics communicatively coupled to the sensor assembly, the meter electronics being provided according to the foregoing.

### ASPECTS

According to an aspect, a method of determining a mass flow rate error correction value for a vibratory meter comprises comparing each of a plurality of mass flow rate measurements of a substitute gas flow with a corresponding each of a plurality of reference mass flow rate measurements of the substitute gas flow, and determining, based on the comparisons, a plurality of mass flow rate measurement errors corresponding to a plurality of fluid velocity-related parameter values of the substitute gas flow.

Preferably, the plurality of fluid velocity-related parameter values of the substitute gas flow comprises one of a plurality of fluid velocity values and a plurality of Mach number values of the substitute gas flow.

Preferably, the plurality of reference mass flow rate measurements of the substitute gas flow is provided by a reference device in line with the vibratory meter.

Preferably, the substitute gas flow comprises one of air, natural gas, carbon dioxide, nitrogen, and helium.

Preferably, the plurality of mass flow rate measurement errors corresponding to the plurality of fluid velocity-related parameter values of the substitute gas flow comprises a plurality of differences between the each of the plurality of mass flow rate measurement values and the corresponding each of the plurality of reference mass flow rate measurement values.

Preferably, the method further comprises flowing the substitute gas flow through the vibratory meter.

Preferably, the method further comprises determining, with the vibratory meter, the plurality of mass flow rate measurements at the corresponding plurality of fluid velocity-related parameter values of the substitute gas flow.

Preferably, the method further comprises storing the plurality of the mass flow rate measurement errors in a meter electronics of the vibratory meter as a plurality of ordered pairs of the plurality of the mass flow rate measurement errors and the corresponding plurality of the fluid velocity-related parameter values.

Preferably, the method further comprises determining a mass flow rate error correction relationship based on the plurality of mass flow rate measurement errors and the corresponding plurality of fluid velocity-related parameter values and storing the mass flow rate error correction relationship in the vibratory meter.

According to an aspect, a system for determining a mass flow rate error correction relationship for a vibratory meter comprises the vibratory meter configured to measure a mass flow rate of a substitute gas flow, a reference device in line with the vibratory meter, the reference device being configured to determine a reference mass flow rate of the substitute gas flow, and a calibration circuit in communication with the vibratory meter and the reference device, the calibration circuit being configured to perform the foregoing methods.

According to an aspect, a method for using a mass flow rate error correction relationship for a vibratory meter comprises determining a fluid velocity-related parameter value of a process gas flow based on a measured mass flow rate value, a density value, and a cross-sectional area of the process gas flow and determining a mass flow rate error correction value based on the fluid velocity-related parameter value.

Preferably, the fluid velocity-related parameter value comprises one of a fluid velocity value and a Mach number value of the process gas flow.

Preferably, the process gas flow is a hydrogen gas flow.

Preferably, the method further comprises measuring, with the vibratory meter, a mass flow rate of the process gas flow to determine the measured mass flow rate value.

Preferably, the method further comprises correcting the measured mass flow rate value with the mass flow rate error correction value.

Preferably, determining the mass flow rate error correction value based on the fluid velocity-related parameter value comprises obtaining the mass flow rate error correction relationship for a substitute gas flow, and determining the mass flow rate correction value based on the mass flow rate error correction relationship for the substitute gas flow and the fluid velocity-related parameter value.

Preferably, the substitute gas flow comprises one of air, natural gas, carbon dioxide, nitrogen, and helium.

According to an aspect, a meter electronics for using a mass flow rate error correction relationship comprises a storage system and a processing system communicatively coupled to the storage system, the processing system being configured to execute the foregoing methods.

According to an aspect, a vibratory meter for using a mass flow rate error correction relationship comprises a sensor assembly configured to measure a mass flow rate of a process gas flow and a meter electronics communicatively coupled to the sensor assembly, the meter electronics being provided according to the foregoing.

### BRIEF DESCRIPTION OF THE DRAWINGS

The same reference number represents the same element on all drawings. It should be understood that the drawings are not necessarily to scale.

FIG. 1 shows a vibratory meter 5 configured to determine and use a mass flow rate error correction relationship for the vibratory meter 5.

FIG. 2 shows a block diagram of the vibratory meter 5, including a block diagram representation of the meter electronics 20, configured to determine and use a mass flow rate error correction value for the vibratory meter 5.

FIG. 3 shows a meter electronics 20 for determining and using a mass flow rate error compensation relationship for the vibratory meter 5.

FIG. 4 shows a graph 400 illustrating a lack of discernible relationship between a mass flow rate error percentage and a mass flow rate.

FIG. 5 shows a graph 500 illustrating a discernible relationship between a mass flow rate error percentage and a fluid velocity-related parameter.

FIG. 6 shows a graph 600 illustrating a discernible relationship between a mass flow rate error percentage and a fluid velocity-related parameter.

FIG. 7 shows a graph 700 illustrating a lack of discernible relationship between a mass flow rate error percentage and a mass flow rate.

FIG. 8 shows a graph 800 illustrating a discernible relationship between a mass flow rate error percentage and a fluid velocity-related parameter.

FIG. 9 shows a graph 900 illustrating a discernible relationship between a mass flow rate error percentage and a fluid velocity-related parameter after a mass flow rate error correction relationship has been applied.

FIG. 10 shows a system 1000 for determining a mass flow rate error correction relationship for a vibratory meter.

FIG. 11 shows a method 1100 of determining a mass flow rate error correction relationship for a vibratory meter, such as the vibratory meter 5 described above.

FIG. 12 shows a method 1200 of using a mass flow rate error correction relationship for a vibratory meter, such as the vibratory meter 5 described above.

### DETAILED DESCRIPTION

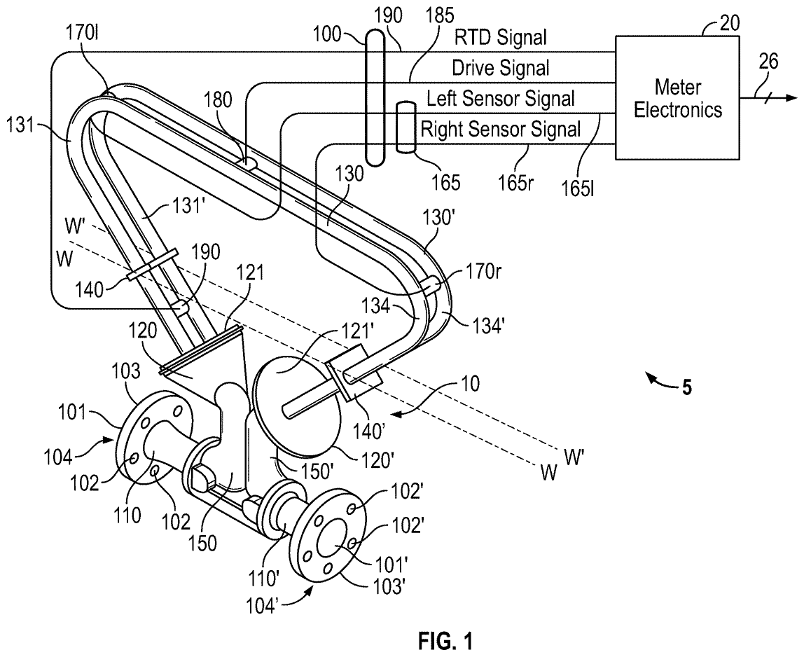

FIGS. 1-12 and the following description depict specific examples to teach those skilled in the art how to make and use the best mode of embodiments of determining and using a mass flow rate error correction relationship for a vibratory meter. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of determining and using the mass flow rate error correction relationship for the vibratory meter. As a result, the embodiments described below are not limited to the specific examples described below, but only by the claims and their equivalents.

FIG. 1 shows a vibratory meter 5 configured to determine and use a mass flow rate error correction relationship for the vibratory meter 5. As shown in FIG. 1, the vibratory meter 5 is a Coriolis flow meter that comprises a sensor assembly 10 and meter electronics 20. The sensor assembly 10 responds to mass flow rate and density of a process material. The meter electronics 20 is connected to the sensor assembly 10 via leads 100 to provide density, mass flow rate, and temperature information over port 26, as well as other information.

The sensor assembly 10 includes a pair of manifolds 150 and 150′, flanges 103 and 103′ having flange necks 110 and 110′, a pair of parallel conduits 130 and 130′, driver 180, resistive temperature detector (RTD) 190, and a pair of pick-off sensors 1701 and 170r. Conduits 130 and 130′ have two essentially straight inlet legs 131, 131′ and outlet legs 134, 134′, which converge towards each other at conduit mounting blocks 120 and 120′. The conduits 130, 130′ bend at two symmetrical locations along their length and are essentially parallel throughout their length. Brace bars 140 and 140′ serve to define the axis W and W′ about which each conduit 130, 130′ oscillates. The legs 131, 131′ and 134, 134′ of the conduits 130, 130′ are fixedly attached to conduit mounting blocks 120 and 120′ and these blocks, in turn, are fixedly attached to manifolds 150 and 150′. This provides a continuous closed material path through sensor assembly 10.

When flanges 103 and 103′, having holes 102 and 102′ are connected, via inlet end 104 and outlet end 104′ into a process line (not shown) which carries the process material that is being measured, material enters inlet end 104 of the vibratory meter through an orifice 101 in the flange 103 and is conducted through the manifold 150 to the conduit mounting block 120 having a surface 121. Within the manifold 150 the material is divided and routed through the conduits 130, 130′. Upon exiting the conduits 130, 130′, the process material is recombined in a single stream within the block 120′ having a surface 121′ and the manifold 150′ and is thereafter routed to outlet end 104′ connected by the flange 103′ having holes 102′ to the process line (not shown).

The conduits 130, 130′ are selected and appropriately mounted to the conduit mounting blocks 120, 120′ so as to have substantially the same mass distribution, moments of inertia and Young's modulus about bending axes W--W and W′--W′, respectively. These bending axes go through the brace bars 140, 140′. Inasmuch as the Young's modulus of the conduits change with temperature, and this change affects the calculation of flow and density, RTD 190 is mounted to conduit 130′ to continuously measure the temperature of the conduit 130′. The temperature of the conduit 130′ and hence the voltage appearing across the RTD 190 for a given current passing therethrough is governed by the temperature of the material passing through the conduit 130′. The temperature dependent voltage appearing across the RTD 190 is used in a well-known method by the meter electronics 20 to compensate for the change in elastic modulus of the conduits 130, 130′ due to any changes in conduit temperature. The RTD 190 is connected to the meter electronics 20 by lead 195.

Both of the conduits 130, 130′ are driven by driver 180 in opposite directions about their respective bending axes W and W′ and at what is termed the first out-of-phase bending mode of the vibratory meter. This driver 180 may comprise any one of many well-known arrangements, such as a magnet mounted to the conduit 130′ and an opposing coil mounted to the conduit 130 and through which an alternating current is passed for vibrating both conduits 130, 130′. A suitable drive signal 185 is applied by the meter electronics 20, via a lead, to the driver 180.

The meter electronics 20 receives the RTD temperature signal on lead 190, and sensor signals 165 appearing on leads 100 carrying left and right sensor signals 1651, 165r, respectively. The meter electronics 20 produces the drive signal 185 appearing on the lead to driver 180 and vibrate conduits 130, 130′. The meter electronics 20 processes the left and right sensor signals 1651, 165r and the RTD signal 190 to compute the mass flow rate and the density of the material passing through sensor assembly 10. This information, along with other information, is applied by meter electronics 20 over path 26 as a signal. A more detailed discussion of the meter electronics 20 follows.

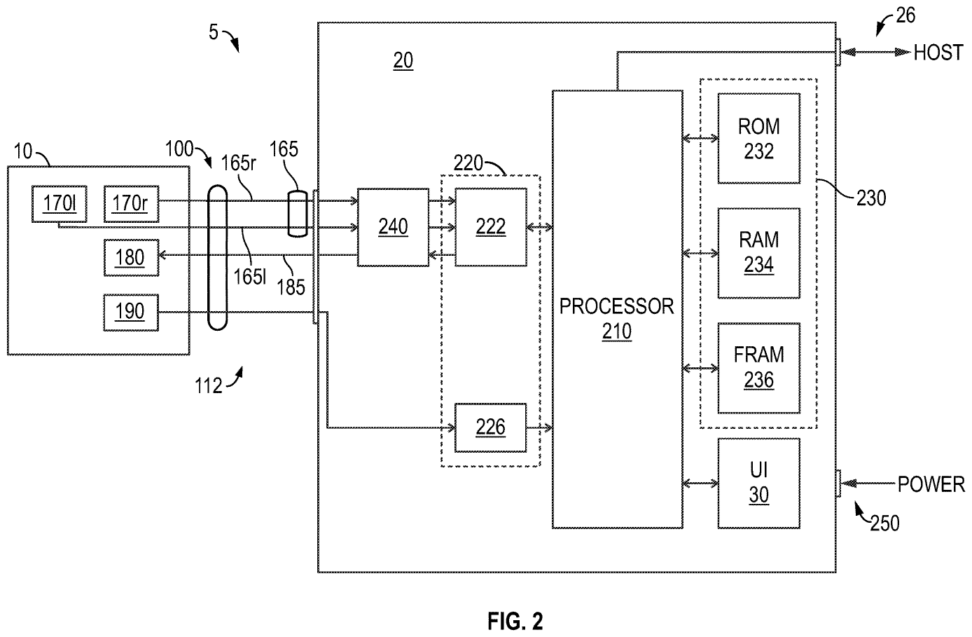

FIG. 2 shows a block diagram of the vibratory meter 5, including a block diagram representation of the meter electronics 20, configured to determine and use mass flow rate error correction value for the vibratory meter 5. As shown in FIG. 2, the meter electronics 20 is communicatively coupled to the sensor assembly 10. As described in the foregoing with reference to FIG. 1, the sensor assembly 10 includes the left and right pick-off sensors 1701, 170r, driver 180, and temperature sensor 190, which are communicatively coupled to the meter electronics 20 via the set of leads 100 through a communications channel 112.

The meter electronics 20 provides a drive signal 185 via the leads 100. More specifically, the meter electronics 20 provides a drive signal 185 to the driver 180 in the sensor assembly 10. In addition, sensor signals 165 comprising the left sensor signal 1651 and the right sensor signal 165r are provided by the sensor assembly 10. More specifically, in the embodiment shown, the sensor signals 165 are provided by the left and right pick-off sensor 1701, 170r in the sensor assembly 10. As can be appreciated, the sensor signals 165 are respectively provided to the meter electronics 20 through the communications channel 112.

The meter electronics 20 includes a processor 210 communicatively coupled to one or more signal processors 220 and one or more memories 230. The processor 210 is also communicatively coupled to a user interface 30. The processor 210 is communicatively coupled with the host via a communication port over the port 26 and receives electrical power via an electrical power port 250. The processor 210 may be a microprocessor although any suitable processor may be employed. For example, the processor 210 may be comprised of sub-processors, such as a multi-core processor, serial communication ports, peripheral interfaces (e.g., serial peripheral interface), on-chip memory, I/O ports, and/or the like. In these and other embodiments, the processor 210 is configured to perform operations on received and processed signals, such as digitized signals.

The processor 210 may receive digitized sensor signals from the one or more signal processors 220. The processor 210 is also configured to provide information, such as a phase difference, a property of a fluid in the sensor assembly 10, or the like. The processor 210 may provide the information to the host through the communication port. The processor 210 may also be configured to communicate with the one or more memories 230 to receive and/or store information in the one or more memories 230. For example, the processor 210 may receive calibration factors, sensor assembly zeros (e.g., phase difference when there is zero flow), and mass flow rate correction values from the one or more memories 230. Each of the calibration factors, sensor assembly zeros, and mass flow rate correction values may respectively be associated with the vibratory meter 5 and/or the sensor assembly 10. The processor 210 may use the calibration factors and/or sensor assembly zeros to process digitized sensor signals received from the one or more signal processors 220 to determine process values, such as a density or mass flow rate. The processor 210 may also use the mass flow rate correction values to correct the mass flow rate determined from the digitized sensor signals.

The one or more signal processors 220 is shown as being comprised of an encoder/decoder (CODEC) 222 and an analog-to-digital converter (ADC) 226. The one or more signal processors 220 may condition analog signals, digitize the conditioned analog signals, and/or provide the digitized signals. The CODEC 222 is configured to receive the sensor signals 165 from the left and right pick-off sensors 1701, 170r. The CODEC 222 is also configured to provide the drive signal 185 to the driver 180. In alternative embodiments, more or fewer signal processors may be employed.

As shown, the sensor signals 165 are provided to the CODEC 222 via a signal conditioner 240. The drive signal 185 is provided to the driver 180 via the signal conditioner 240. Although the signal conditioner 240 is shown as a single block, the signal conditioner 240 may be comprised of signal conditioning components, such as two or more op-amps, filters, such as low pass filters, voltage-to-current amplifiers, or the like. For example, the sensor signals 165 may be amplified by a first amplifier and the drive signal 185 may be amplified by the voltage-to-current amplifier. The amplification can ensure that the magnitude of the sensor signals 165 is approximate the full-scale range of the CODEC 222.

In the embodiment shown, the one or more memories 230 is comprised of a read-only memory (ROM) 232, random access memory (RAM) 234, and a ferroelectric random-access memory (FRAM) 236. However, in alternative embodiments, the one or more memories 230 may be comprised of more or fewer memories. Additionally, or alternatively, the one or more memories 230 may be comprised of different types of memory (e.g., volatile, non-volatile, etc.). For example, a different type of non-volatile memory, such as, for example, erasable programmable read only memory (EPROM), or the like, may be employed instead of the FRAM 236. The one or more memories 230 may be a storage configured to store process data, such as drive or sensor signals, mass flow rate or density measurements, etc.

A mass flow rate measurement can be generated according to the equation:

$$\dot{m} = FCF [ Δ t - Δ {t}_{0} ] ; \qquad [ 1 ]$$

where:
\dot{m} is a measured mass flow rate;
FCF is a flow calibration factor;
Δt is a measured time delay; and
Δt₀ is a zero-flow time delay.
   The measured time delay Δt comprises an operationally derived (i.e., measured) time delay value comprising the time delay existing between the pickoff sensor signals, such as where the time delay is due to Coriolis effects related to mass flow rate through the vibratory meter 5. The measured time delay Δt is a direct measurement of a mass flow rate of the flow material as it flows through the vibratory meter 5. The zero-flow time delay Δt₀ comprises a time delay at a zero flow. The zero-flow time delay Δt₀ is a zero-flow value that may be determined at the factory and programmed into the vibratory meter 5. The zero-flow time delay Δt₀ is an exemplary zero-flow value. Other zero-flow values may be employed, such as a phase difference, time difference, or the like, that are determined at zero flow conditions. A value of the zero-flow time delay Δt₀ may not change, even where flow conditions are changing. A mass flow rate value of the material flowing through the vibratory meter 5 is determined by multiplying a difference between measured time delay Δt and a reference zero-flow value Δt₀ by the flow calibration factor FCF. The flow calibration factor FCF is proportional to a physical stiffness of the vibratory meter.

As to density, a resonance frequency at which each conduit 130, 130′ may vibrate may be a function of the square root of a spring constant of the conduit 130, 130′ divided by the total mass of the conduit 130, 130′ having a material. The total mass of the conduit 130, 130′ having the material may be a mass of the conduit 130, 130′ plus a mass of a material inside the conduit 130, 130′. The mass of the material in the conduit 130, 130′ is directly proportional to the density of the material. Therefore, the density of this material may be proportional to the square of a period at which the conduit 130, 130′ containing the material oscillates multiplied by the spring constant of the conduit 130, 130′. Hence, by determining the period at which the conduit 130, 130′ oscillates and by appropriately scaling the result, an accurate measure of the density of the material contained by the conduit 130, 130′ can be obtained. The meter electronics 20 can determine the period or resonance frequency using the sensor signals 165 and/or the drive signal 185. The conduits 130, 130′ may oscillate with more than one vibration mode.

The vibratory meter 5 may be calibrated with a factory zero-flow value while the vibratory meter 5 is in a no or zero-flow condition. A user, at any time, may additionally, and optionally, perform a push-button calibration to obtain a push-button zero-flow value. Additionally, or alternatively, the vibratory meter may automatically perform a calibration to obtain an automatic zero-flow value. The zero-flow value used to measure a flow rate of a fluid may be the factory zero-flow value, a push-button zero-flow value, the automatic zero-flow value, or any other suitable zero-flow value.

Measurements, saved values/constants, user settings, saved tables, etc., may be employed during the zero calibration of the vibratory meter 5. The calibration may monitor the vibratory meter 5 for conditions of the vibratory meter 5 and compensate for those conditions. The conditions may include user-input conditions, measured conditions, inferred conditions, or the like, without limitation. The conditions may include temperature, fluid density, flow rate, meter specifications, viscosity, Reynold's number, post calibration compensation, etc. In addition, different constants, such as a flow calibration factor (FCF), for example without limitation, may be applied based on operating conditions or user preference.

An initial zero-flow value may be determined during a calibration conducted as part of the initial factory setup of the vibratory meter 5. This may entail placing the vibratory meter 5 in a no or zero-flow condition and determining a time delay, phase difference, or the like, between the left and right sensor signals 1651, 165r. The determined value is stored in one or more memories 230 as the initial zero-flow value and used as a reference zero-flow value. By way of example, for equation [1] discussed above, the reference zero-flow value may be the ΔT₀ term, which may be a no or zero-flow time delay between the left and right sensor signals 1651, 165r. Once the reference zero-flow value is determined, the flow calibration factor (FCF) may be established, which, as can be appreciated from above equation [1], may be a slope of a line that dictates the relationship between the measured time delay Δt_{measured} and the mass flow rate \dot{m}. The FCF may be stored in the one or more memories 230.

### Correcting Measured Mass Flow Rates of Process Gas Flows

When vibratory meters, such as Coriolis meters, are tested in a gas laboratory, the exact gas and process conditions of the final application cannot always be duplicated. Historically, vibratory meters used in gas flow applications have tried to use equivalent flowing gas density or Reynolds Number or mass-based comparisons. Although these can be useful techniques for other technologies (e.g., orifice plate meters), it is not always the optimum basis of comparison for a vibratory meter. To create a common basis of comparison between test gas conditions and application conditions for the purpose of linearizing the meter adjustment for optimum measurement accuracy over a range of flow rates, Mach number could be used as the input value to describe the linearization correction value function. Alternatively, fluid velocity could be used as the function input in cases where the molecular weight, speed of sound, and chemical composition of the gas is not fully known.

Vibratory meters can be optimized for gas measurement accuracy by defining a linearization curve on the basis of mass flow rate as the input variable, so long as the gas to be measured will be of similar properties. It is possible to achieve optimum measurement by linearizing the meter with a correction curve that has velocity as the input variable when gases that may have very different densities might later be measured. Furthermore, it is possible to achieve optimum measurement by linearizing the meter with a correction curve that has Mach number as the input variable because Mach number takes into account gas velocity as well as the molecular weight of the gas. These combined parameters are better predictors of flow conditions that will impact the vibratory meter's measurement accuracy.

Vibratory meters are directly impacted by the flow noise and other conditions in ways that are uniquely associated with gas flows different than with liquid flows. For example, broad-based white noise and other effects that only occur because of the compressibility of gaseous-phase flow streams interfere with the fundamental measurement signal and can degrade the measurement in a way that can cause greater non-linearity over a range of flow rates than would normally be seen with liquid flows. The severity of this impact can be directly tracked with Mach number as determined by the velocity of the gas in the flow tubes. As the flow tube velocity exceeds 0.2 Mach some evidence of performance degradation (accuracy and repeatability) can be observed, and as it exceeds 0.3 Mach a significant degradation in performance is likely.

Typical compensation schemes for vibratory meters either apply a correction at all flow conditions with a single meter factor (e.g., flow-weighted mean average as described in AGA Report No. 11), or apply variable corrections (i.e., linearization correction curves) based on mass flow. Mass flow rate-based correction curves or data are not readily transferable between gases of different composition and/or density, as mass rates will differ significantly as process conditions change between gas type and density. For instance, non-linearities observed in a natural gas testing lab are not as likely to be duplicated in a hydrogen measurement application as a function of mass flow rate than as a function of velocity or Mach number.

In addition, using gases as a calibration medium, especially for measuring instruments with a pressure drop is the rangeability and the maximum flow rate that can be achieved at different conditions. This is attributed to the maximum allowable velocity of the fluid through the vibratory meter. For example, at lower pressures, a maximum mass flow rate possible through a vibratory meter is significantly reduced. Accordingly, instead of generating a mass error vs. mass flow rate, the measuring instrument behavior can be described in terms of mass error vs. the fluid velocity-related parameter of the gas flow as, for example, a fraction of the speed of sound or Mach number. The Mach number for a gas is defined as the velocity of that gas as a fraction of the speed of sound and is described in equation [2]:

$$M = \frac{v}{c} ; \qquad [ 2 ]$$

where:
M is the Mach number;
ν is the fluid velocity; and
c is the speed of sound within the fluid.

Due to the low density of hydrogen (H₂), the speed of sound of most substitute gases is lower than that of H₂. This may make the maximum mass/volume flow rate significantly higher for H₂ gas than it is for most other gases at a given Mach number. For example, a 0.3 Mach flow rate of natural gas with a speed of sound of 466 m/s may be about 140 m/s. In contrast, a 0.3 Mach flow rate of H₂ gas with a speed of sound equal to 1320 m/s may be about 396 m/s (2.8 times higher than natural gas). The maximum flow rate (Qₘₐₓ) of a vibratory meter can be set at 0.3 Mach for all gas compositions which will be a different maximum velocity in units of m/s for each different gas (depending on the speed of sound in that gas).

### Correction Methods Using Fluid Velocity-Related Parameters

As is suggested above and described in more detail below, a solution for the transferability between gases and rangeability and maximum flow rate of a vibratory meter is to apply a mass flow rate error correction relationship based on a fluid velocity-related parameter, such as, for example, a Mach number, fluid velocity, or the like, in order to linearize the output of the vibratory meter based on Mach number or fluid velocity for gas flows. The fluid velocity-related parameter may by any parameter that is or includes a fluid velocity term.

In the specific examples of the Mach number and fluid velocity, the Mach number may be preferred over the fluid velocity when the gas molecular weight and/or speed of sound is known from analysis of the chemical composition of the gas. However, the fluid velocity method can be employed if the properties and composition of the gas are not known by simply measuring the mass flow rate and flowing density of the gas, and by applying the known cross-sectional area of the flow meter through the flow tubes. Exemplary specific details of these calculations are discussed in the following.

A fluid velocity may be determined using equation [3].

$$v = \frac{\dot{m}}{( A \cdot ρ )} ; \qquad [ 3 ]$$

where:
ν is a fluid velocity;
\dot{m} is a mass flow rate (e.g., lbs/sec);
A is a cross-sectional area of a fluid flow (ft²); and
ρ is a density of the fluid flow (lbs/ft³).
   A Mach number in imperial units may be determined using equations [4] or [5]:

$${m}_{a} = \frac{\dot{m} / ( A \cdot ρ )}{( 223 \sqrt{T \cdot z \cdot k} ) / mW} ; or \qquad [ 4 ]$$

$${m}_{a} = \frac{\dot{m} / ( A \cdot ρ )}{SOS} . \qquad [ 5 ]$$

where:
\dot{m} is a mass flow rate (e.g., lbs/sec);
A is a cross-sectional area of a fluid flow (ft²); and
ρ is a density of the fluid flow (lbs/ft³).
T is an absolute temperature of a gas;
z is a super-compressibility of the gas;
k is a specific heat ratio of the gas;
mW is a molecular weight of the gas; and
SOS is a speed of sound value of the gas.

In order to accomplish a Mach number-based compensation, a user of a vibratory meter, such as the vibratory meter 5 discussed above, may need to enter the molecular weight mW and/or speed of sound (SOS) of the calibration or substitute gas during calibration and later the molecular weight and/or SOS of a process gas being measured after installation of a vibratory meter. In order to calibrate and apply the necessary correction relationship (e.g., function, relationship, curve, ordered pairs, etc.) for Mach number, the meter electronics would determine a correction factor for every test flow rate based on a Mach number that is to be determined by the flowing velocity (determined from the mass flow rate, density, and meter cross-sectional area), and the molecular weight or speed of sound of the calibration gas.

The mass flow rate error correction relationship, whether Mach number based, fluid velocity based, or the like, could be formed by any standard method of fitting a curve to the calibration data, such as linear interpolation between neighboring points or polynomial fit. All corrections applied later during process gas measurement could be determined through, for example, the linearization correction algorithm and could be based on the fluid velocity, Mach number, or other fluid velocity-related parameter, observed and matched to the error as observed during calibration at the same fluid velocity value, Mach number value, or the like. Once a meter electronics, such as the meter electronics 20 discussed above, has determined m_{α} or ν, a look up table and/or curve would be used to find the stored linearization compensation value at any measured Mach number or fluid velocity. This mass flow rate error compensation value could then be used to compensate the mass flow rate value, as the following exemplary equation [6] illustrates:

$${\dot{m}}_{c} = \dot{m} ( 1 + {L}_{mach} / 100 ) ; \qquad [ 6 ]$$

where:
\dot{m} is a measured mass flow rate (e.g., a current or uncompensated measured mass flow rate);
\dot{m}_{c} is a compensated mass flow rate; and
L_{mach} is a linearization compensation factor based on a Mach number (%) (or fluid velocity).
   As can be appreciated, any suitable means of determining the corrected mass flow rate value may be employed, including those that do not rely on the above equation [6].

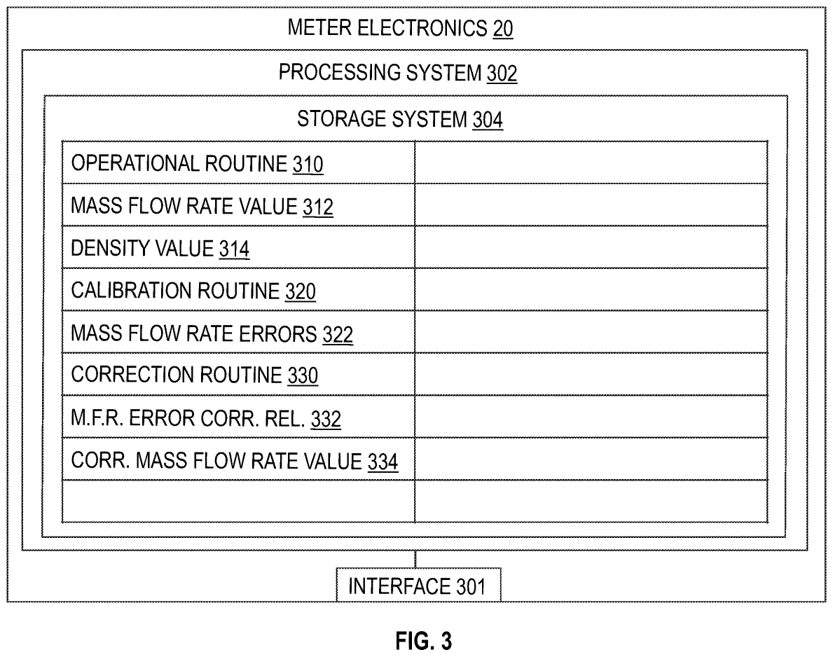

FIG. 3 shows a meter electronics 20 for determining and using a mass flow rate error compensation relationship for the vibratory meter 5. As shown in FIG. 3, the meter electronics 20 includes an interface 301 and a processing system 302. The meter electronics 20 receives a vibrational response from a sensor assembly, such as the sensor assembly 10, for example. The meter electronics 20 processes the vibrational response in order to obtain flow properties of the flow material flowing through the sensor assembly 10. The meter electronics 20 may also perform checks, verifications, calibration routines, or the like, to ensure the flow properties of the flow material are accurately measured.

The interface 301 may receive the sensor signals 165 from one of the pick-off sensors 1701, 170r shown in FIGS. 1 and 2. The interface 301 can perform any necessary or desired signal conditioning, such as any manner of formatting, amplification, buffering, etc. Alternatively, some or all of the signal conditioning can be performed in the processing system 302. In addition, the interface 301 can enable communications between the meter electronics 20 and external devices. The interface 301 can be capable of any manner of electronic, optical, or wireless communication. The interface 301 can provide information based on the vibrational response. The interface 301 may be coupled with a digitizer, such as the CODEC 222 shown in FIG. 2, wherein the sensor signal comprises an analog sensor signal. The digitizer samples and digitizes an analog sensor signal and produces a digitized sensor signal.

The processing system 302 conducts operations of the meter electronics 20 and processes flow measurements from the sensor assembly 10. The processing system 302 executes one or more processing routines and thereby processes the flow measurements in order to produce one or more flow properties. The processing system 302 is communicatively coupled to the interface 301 and is configured to receive the information from the interface 301.

The processing system 302 can comprise a general-purpose computer, a micro-processing system, a logic circuit, or some other general purpose or customized processing device. Additionally, or alternatively, the processing system 302 can be distributed among multiple processing devices. The processing system 302 can also include any manner of integral or independent electronic storage medium, such as the storage system 304.

The storage system 304 can store vibratory meter parameters and data, software routines, constant values, and variable values. In one embodiment, the storage system 304 includes routines that are executed by the processing system 302, such as an operational routine 310, calibration routine 320, and correction routine 330 of the vibratory meter 5. The storage system can also store statistical values, such as a mean, standard deviation, confidence interval, etc., or the like.

The operational routine 310 may determine a mass flow rate value 312 and a density value 314 based on the sensor signals received by the interface 301. The mass flow rate value 312 may therefore be an uncorrected and directly measured mass flow rate value, or the like. The mass flow rate value 312 may be determined from the sensor signals, such as a time delay between a left pickoff sensor signal and a right pickoff sensor signal. The density value 314 may also be determined from the sensor signals by, for example, determining a frequency from one or both of the left and right pickoff sensor signals.

The calibration routine 320 may perform a zero verification, a flow calibration factor determination, and/or a mass flow rate error relationship determination and/or correction described above, although any suitable calibration routines may be employed. Accordingly, the calibration routine 320 may determine a plurality of mass flow rate errors 322. The mass flow rate errors 322 may be mass flow rate based and/or based on a fluid velocity-related parameter (e.g., Mach number, fluid velocity, etc.). For example, the mass flow rate errors 322 may be comprised of one or more relationships, such as two tables, functions, or the like, that relate a mass flow rate and/or a Mach number or fluid velocity to mass flow rate errors.

The storage system 304 is also shown as including a correction routine 330. The correction routine 330 may use a mass flow rate error correction relationship 332 to correct an uncorrected mass flow rate, such as the mass flow rate value 312 shown in FIG. 3, to determine a corrected mass flow rate value 334. For example, the mass flow rate error correction relationship 332 may be a function based on the mass flow rate errors 322 determined by the calibration routine 320. The mass flow rate error correction relationship 332 may be based on a fluid-velocity based parameter, such as Mach number or fluid velocity, of a substitute gas flow, as is described in more detail in the following.

### Mass Flow Rate Vs Fluid Velocity-Related Based Measurement Errors

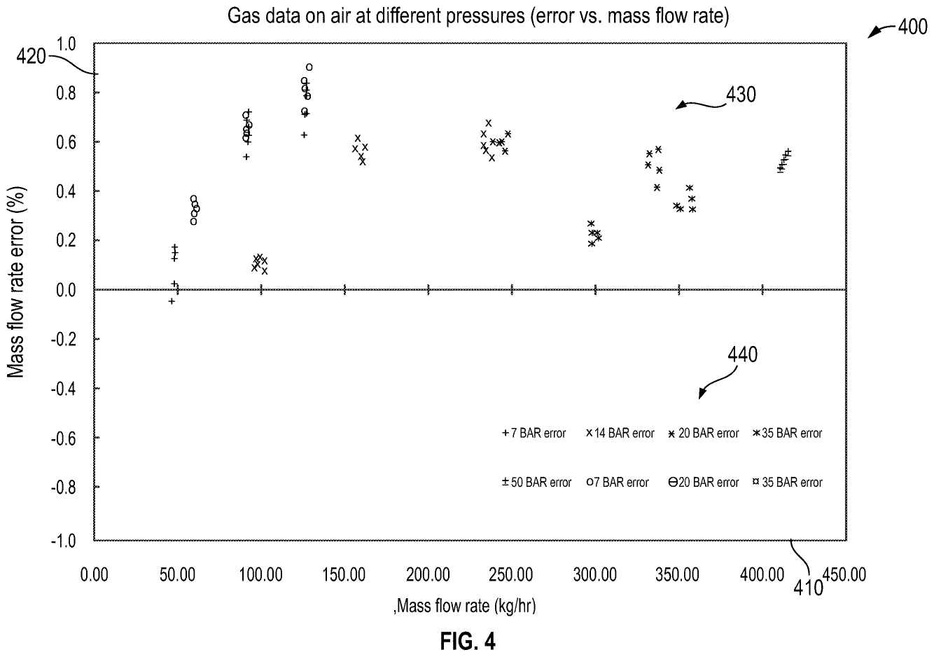

As discussed above, substitute gas flows may be used during calibration to determine mass flow rate error correction relationships that can be used to correct an uncorrected mass flow rate value. However, a mass flow rate error correction relationship that is based on a mass flow rate may not be transferable to other gases. As the following FIGS. 4-9 illustrate, a mass flow rate error correction relationship based on a fluid velocity-related parameter, such as a Mach number or fluid velocity, may be transferable to other gases, including those with significantly unique mass flow rate based non-linearities due to high compressibility, such as hydrogen.

FIG. 4 shows a graph 400 illustrating a lack of discernible relationship between a mass flow rate error percentage and a mass flow rate. As shown in FIG. 4, the graph 400 includes a mass flow rate axis 410 in units of kilograms-per-hour (kg/hr) and a mass flow rate error axis 420 having a unitless scale of percentage. The mass flow rate axis 410 ranges from 0.00 to 450 kg/hr and the mass flow rate error axis 420 ranges from −1.0 to 1.0%. The graph 400 also includes a mass flow rate error scatter plot 430 of air at various mass flow rates and pressures. As can be appreciated from the legend 440, the air flow has pressures that range from 7 bars to 50 bars. As can also be appreciated from the mass flow rate error scatter plots 430 and the legend 440, the air flow was tested several times at each pressure.

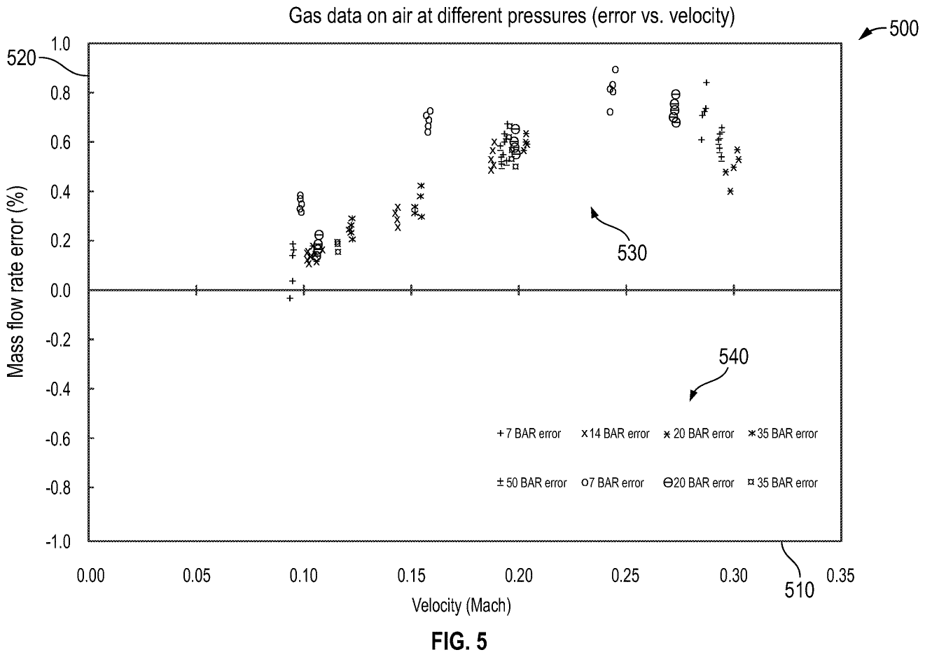

FIG. 5 shows a graph 500 illustrating a discernible relationship between a mass flow rate error percentage and a fluid velocity-related parameter. As shown in FIG. 5, the graph 500 includes a fluid velocity axis 510 having unitless Mach numbers and a mass flow rate error axis 520 having a unitless scale of percentage. The fluid velocity axis 510 ranges from 0.00 to 0.35 Mach and the mass flow rate error axis 520 ranges from −1.0 to 1.0%. The graph 500 also includes a mass flow rate error scatter plot 530 of air at various mass flow rates and pressures. As can be appreciated from the legend 540, the air flow has pressures that range from 7 bars to 50 bars. As can also be appreciated from the mass flow rate error scatter plots 530 and the legend 540, the air flow was tested several times at each pressure.

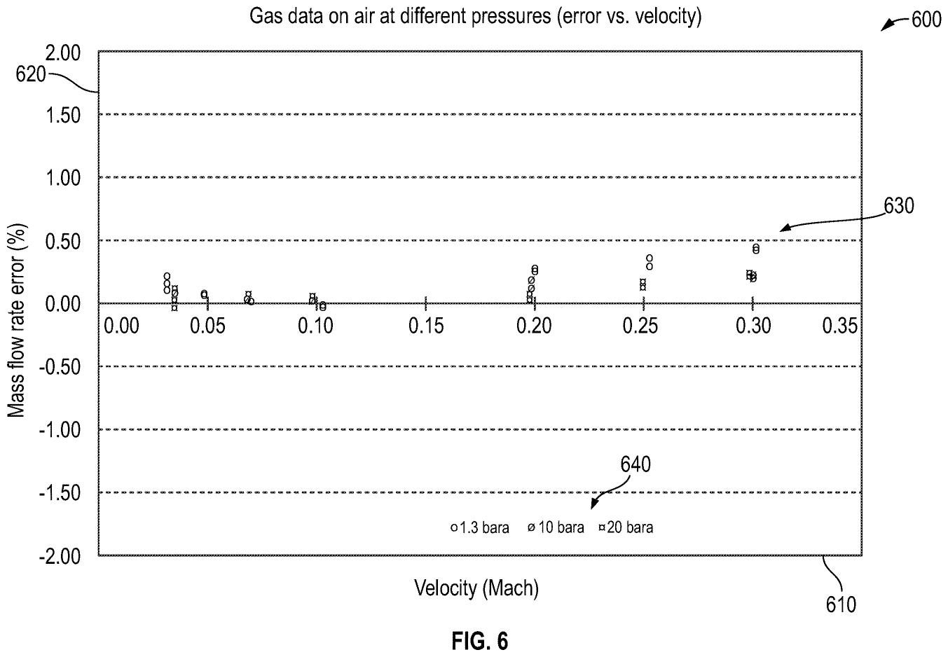

FIG. 6 shows a graph 600 illustrating a discernible relationship between a mass flow rate error percentage and a fluid velocity-related parameter. As shown in FIG. 6, the graph 600 includes a fluid velocity axis 610 having unitless Mach numbers and a mass flow rate error axis 620 having a unitless scale of percentage. The fluid velocity axis 610 ranges from 0.00 to 0.35 and the mass flow rate error axis 620 ranges from −2.0 to 2.0%. The graph 600 also includes a mass flow rate error scatter plot 630 of air at various mass flow rates and pressures. As can be appreciated from the legend 640, the air flow has pressures that range from 1.3 bars to 20 bars. As can also be appreciated from the mass flow rate error scatter plots 630 and the legend 640, the air flow was tested several times at each pressure.

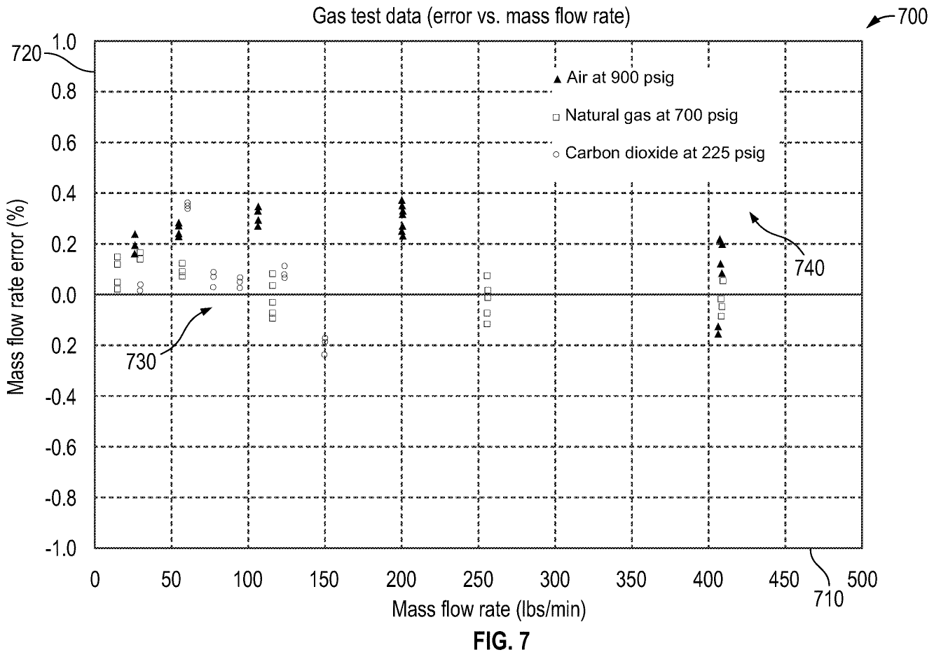

As can be understood from FIGS. 4-6, the mass flow rate error scatter plot 430 shown in FIG. 4 has no discernible relationship between mass flow rate error values and mass flow rate values. In contrast, the mass flow rate error scatter plots 530, 630 shown in FIGS. 5 and 6 have a significantly better and more discernible relationship between mass flow rate error values and Mach number values. As can also be appreciated from FIGS. 5 and 6, the relationship between mass flow rate error values and the Mach number values is discernible over various pressure values of air. The following FIGS. 7-9 illustrate that mass flow rate error correction relationships based on a fluid velocity-related parameter, such as Mach number, fluid velocity, or the like, can be transferable between different gases.

### Exemplary Correction of a Mass Flow Rate of a Process Fluid

FIG. 7 shows a graph 700 illustrating a lack of discernible relationship between a mass flow rate error percentage and a mass flow rate. As shown in FIG. 7, the graph 700 includes a mass flow rate axis 710 in units of pounds-per-minute (lbs/min) and a mass flow rate error axis 720 having a unitless scale of percentage. The mass flow rate axis 710 ranges from 0.00 to 500 lbs/min and the mass flow rate error axis 720 ranges from −1.0 to 1.0%. The graph 700 also includes a mass flow rate error scatter plot 730 of air, natural gas, and carbon dioxide at various mass flow rates and pressures. As can be appreciated from the legend 740, the air flow has a pressure of 900 pounds-per-square inch gauge (psig), natural gas has a pressure of 700 psig, and carbon dioxide has a pressure of 225 psig. As can also be appreciated from the mass flow rate error scatter plots 730 and the legend 740, the air, natural gas, and carbon dioxide flows were tested at various mass flow rates up to about 400 lbs/min.

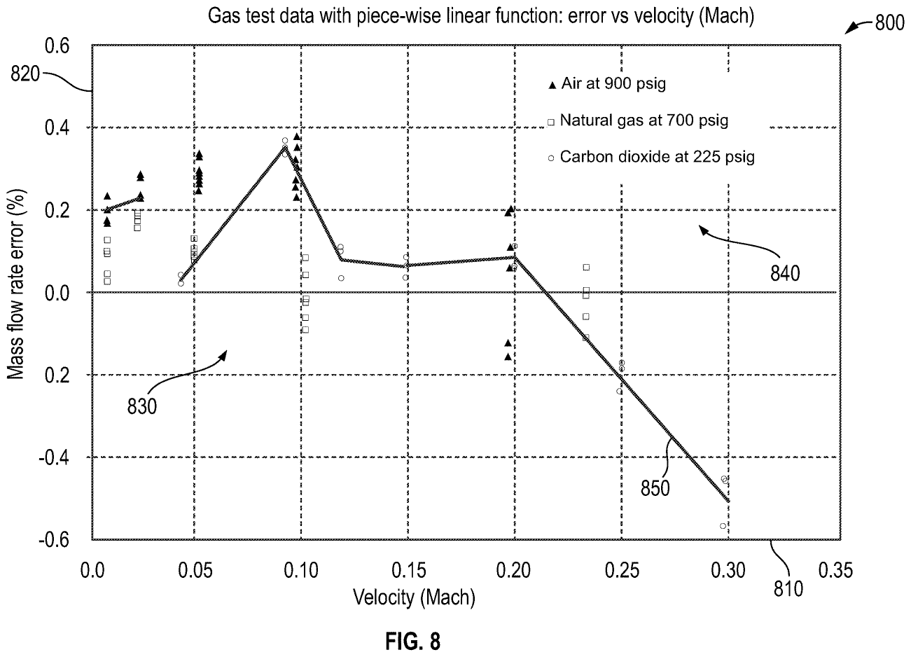

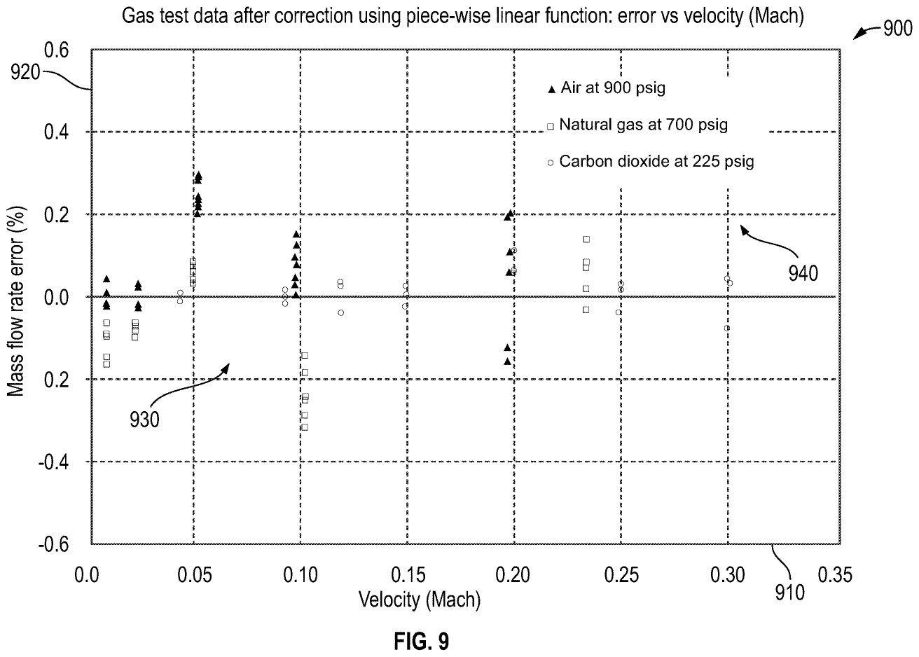

Similar to the mass flow rate error scatter plot 430 described with reference to FIG. 4, the mass flow rate error scatter plot 730 shown in FIG. 7 also has no discernible relationship between mass flow rate error values and mass flow rate values of different gases. Turning now to FIGS. 8 and 9, it can be appreciated that there is a discernible relationship between mass flow rate error values and fluid velocity-related parameter values, in particular Mach number values, for different gases and due to the discernible relationship, a quantifiable relationship between mass flow rate measurement error and fluid velocity-related parameters may be constructed.

FIG. 8 shows a graph 800 illustrating a discernible relationship between a mass flow rate error percentage and a fluid velocity-related parameter. As shown in FIG. 8, the graph 800 includes a fluid velocity axis 810 having unitless Mach numbers and a mass flow rate error axis 820 having a unitless scale of percentage. The fluid velocity axis 810 ranges from 0.00 to 0.35 and the mass flow rate error axis 820 ranges from −0.6 to 0.6%. The graph 800 also includes a mass flow rate error scatter plot 830 of air, natural gas, and carbon dioxide at various fluid velocity rates and pressures. As can be appreciated from the legend 840, the air flow has a pressure of 900 psig, natural gas has a pressure of 700 psig, and carbon dioxide has a pressure of 225 psig. As can also be appreciated from the mass flow rate error scatter plots 830 and the legend 840, the air, natural gas, and carbon dioxide flows were tested at various fluid velocities up to Mach 0.30. Also shown in FIG. 8 is a piece wise linear (PWL) function 850 that is determined from regression analysis of the carbon dioxide data. In particular, an average value of each group of carbon dioxide mass flow rate error values at each velocity (Mach) value is determined. Lines are constructed with each end point at each average value.

FIG. 9 shows a graph 900 illustrating a discernible relationship between a mass flow rate error percentage and a fluid velocity-related parameter after a mass flow rate error correction relationship has been applied. As shown in FIG. 9, the graph 900 includes a fluid velocity axis 910 having unitless Mach numbers and a mass flow rate error axis 920 having a unitless scale of percentage. The fluid velocity axis 910 ranges from 0.00 to 0.35 and the mass flow rate error axis 920 ranges from −0.6 to 0.6%. The graph 900 also includes a mass flow rate error scatter plot 930 of air, natural gas, and carbon dioxide at various fluid velocity rates and pressures. As can be appreciated from the legend 940, the air flow has a pressure of 900 psig, natural gas has a pressure of 700 psig, and carbon dioxide has a pressure of 225 psig. As can also be appreciated from the mass flow rate error scatter plots 930 and the legend 940, the air, natural gas, and carbon dioxide flows were tested at various fluid velocities up to Mach 0.30.

The mass flow rate error scatter plot 930 of FIG. 9 is obtained by applying the PWL function 850 of FIG. 8 as a correction function to the mass flow rate error scatter plot 830 of FIG. 8. In particular, a value of the PWL function 850 is subtracted from the value or values of the mass flow rate error scatter plot 830. As can be appreciated from FIG. 9, the mass flow rate error scatter plot 930 has mass flow rate error values that are less than 0.4% and, in most cases, less than 0.2%.

Although the PWL function 850 is determined by averaging carbon dioxide, any suitable means of determining any suitable relationship between mass flow rate error and the fluid velocity-related parameter, such as one or more functions, table of ordered pairs, and/or the like, may be employed. For example, an alternative function may be a PWL function that has endpoints determined by averaging the mass flow rate error values of all of the gases within a certain range of a fluid velocity-related parameter value. By way of illustration, as can be seen in FIG. 8., the natural gas and air were frequently measured at about the same Mach number. Additionally, or alternatively, an alternative function and/or ordered pairs may be non-linear based and/or determined by using non-linear regression, such as, for example, one or more polynomial functions and/or polynomial regression.

As can be appreciated from the foregoing discussion, determining the mass flow rate error relationship may require determining a “known” mass flow rate. The known mass flow rate may be provided by, for example, a reference flow meter, a source that provides a gas flow at a gas flow rate within a very small range of a setpoint value, and/or the like. These and other devices may be collectively referred to as a reference device. The reference device may be in-line with a vibratory meter, such as the vibratory meter 5 described above for example. Accordingly, the reference device therefore may provide a known or reference mass flow rate and/or fluid velocity-related parameter value that can be used to calibrate the in-line vibratory meter. The below describes an exemplary system utilizing a reference device.

### System

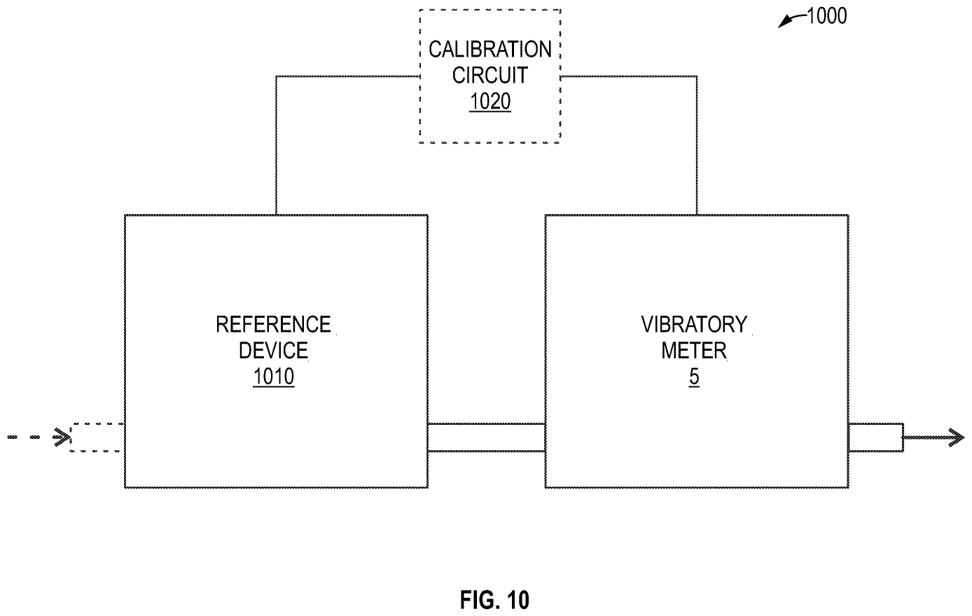

FIG. 10 shows a system 1000 for determining a mass flow rate error correction relationship for a vibratory meter. As shown in FIG. 10, the system 1000 includes the vibratory meter 5 described above, although any suitable vibratory meter may be employed. The vibratory meter 5 is shown as being in-line and in fluid communication with a reference device 1010. That is, the reference device 1010 and the vibratory meter 5 convey a same gas flow. Accordingly, a valid assumption may be made that a measured value of a parameter of the gas flow determined by vibratory meter 5 and the reference device 1010 should be the same. Additionally, a valid assumption may be made that any difference between the measured value of the parameter determined by vibratory meter 5 and the reference device 1010 is due to a measurement error by the vibratory meter 5.

As shown in FIG. 10, the system 1000 includes a calibration circuit 1020 communicatively coupled to the vibratory meter 5 and the reference device 1010. The calibration circuit 1020 is shown in dashed lines to illustrate that the calibration circuit 1020 may or may not be separate from the vibratory meter 5 and/or the reference device 1010 and may or may not be unitary. Regardless of the form factor, the calibration circuit 1020 may determine a difference between measured values of a parameter of the gas flow provided by the vibratory meter 5 and the reference device 1010.

The difference between the measured values of the parameter of the gas flow may be a measured mass flow rate difference between mass flow rate values provided by the vibratory meter 5 and the reference device 1010, which may be referred to as a measured mass flow rate difference. The measured mass flow rate difference may be divided by the mass flow rate value provided by, for example, the reference device and multiplied by 100 to determine a mass flow rate error value in percentages.

Additionally, the calibration circuit 1020 may obtain a fluid flow rate or fluid velocity-related parameter from the reference device 1010 and/or the vibratory meter 5. By way of illustration, the calibration circuit 1020 may obtain a mass flow rate and/or a fluid velocity-related parameter, such as a fluid velocity and/or Mach number of the gas flow from the, for example, reference device 1010. Accordingly, the calibration circuit 1020 may determine, such as calculate, a plurality of mass flow rate errors of the vibratory meter 5 at corresponding plurality mass flow rates and/or fluid velocity-related parameter values.

The calibration circuit 1020 may also determine a function or functions, ordered pairs of numbers, and/or the like that relate a mass flow rate value and/or a fluid velocity-related parameter value, such as a fluid velocity value or a Mach number value, to a mass flow rate error correction value, as is discussed above with reference to FIG. 9. Accordingly, the system 1000 or, in particular, the reference device 1010, whether stand alone or integrated with the vibratory meter 5 and/or the reference device 1010, may provide the function or functions, order pairs of numbers, and/or the like that can be used to correct a measured mass flow rate error of the vibratory meter 5. Exemplary methods of doing so are discussed in detail in the following.

### Methods

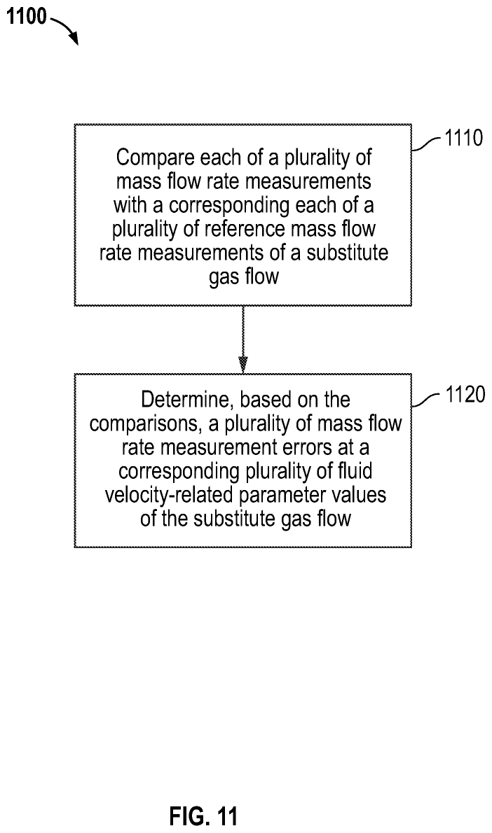

FIG. 11 shows a method 1100 of determining a mass flow rate error correction relationship for a vibratory meter, such as the vibratory meter 5 described above. As shown in FIG. 11, the method 1100 compares each of a plurality of mass flow rate measurements of a substitute gas flow with a corresponding each of a plurality of reference mass flow rate measurements of the substitute gas flow in step 1110. In step 1120, the method 1100 determines, based on the comparisons, a plurality of mass flow rate measurement errors corresponding to a plurality of fluid velocity-related parameter values of the substitute gas flow.

As explained above with reference to FIG. 10, the plurality of reference mass flow rate measurements may be determined and provided by a reference device, such as the reference device 1010 described with reference to FIG. 10. Accordingly, for example, the system 1000, comprising the vibratory meter 5 configured to measure a mass flow rate of a substitute gas flow, the reference device 1010 in line with the vibratory meter 5, and a calibration circuit 1020 in communication with the vibratory meter 5 and the reference device 1010 can perform the steps of method 1100.

For example, the vibratory meter 5 can determine the mass flow rate measurement values and the reference device 1010 can determine the reference mass flow rate of the substitute gas flow. Accordingly, the plurality of reference mass flow rate measurements of the substitute gas flow may be provided by the reference device 1010 in line with the vibratory meter 5. The calibration circuit 1020 can use the mass flow rate measurement values and the reference mass flow rate of the substitute gas flow configured to perform the method 1100.

As can be appreciated from the above discussion, the plurality of fluid velocity-related parameter values of the substitute gas flow may comprise one of a plurality of fluid velocity values and a plurality of Mach number values of the substitute gas flow. The substitute gas flow may comprise air, natural gas, carbon dioxide, nitrogen, and/or helium. As the foregoing discussion related to FIGS. 8 and 9 demonstrate, the plurality of mass flow rate measurement errors and, as a result, the mass flow rate error correction relationship, is transferable to another gas, such as hydrogen. The plurality of mass flow rate measurement errors corresponding to the plurality of fluid velocity-related parameter values of the substitute gas flow may comprise a plurality of differences between the each of the plurality of mass flow rate measurement values and the corresponding each of the plurality of reference mass flow rate measurement values.

The method 1100 may further comprise additional steps. For example, the method 1100 may include flowing the substitute gas flow through the vibratory meter 5, although any suitable vibratory meter may be employed. Accordingly, the vibratory meter may provide the plurality of mass flow rate measurement values. Additionally, or alternatively, the method 1100 may further comprise determining, with the vibratory meter 5, the plurality of mass flow rate measurements at the corresponding plurality of fluid velocity-related parameter values of the substitute gas flow. This can include calculating the fluid velocity-related parameter values according to the above equations [2]-[5], although any suitable equation may be employed.

The method 1100 can also store the plurality of the mass flow rate measurement errors in a meter electronics of the vibratory meter, such as the meter electronics 20 of the vibratory meter 5 described above, as a plurality of ordered pairs of the plurality of the mass flow rate measurement errors and the corresponding plurality of the fluid velocity-related parameter values. Accordingly, the meter electronics can subsequently determine the mass flow rate error correction relationship such as, for example, after the installation of the vibratory meter 5 in a process application.

The method 1100 may further determine a mass flow rate error correction relationship based on the plurality of mass flow rate measurement errors and the corresponding plurality of fluid velocity-related parameter values and storing the mass flow rate error correction relationship in the vibratory meter. For example, the calibration circuit 1020, whether stand alone, in the vibratory meter, and/or reference device 1010, can determine the mass flow rate error correction relationship and store the mass flow rate error correction relationship in the meter electronics of the vibratory meter.

As can be appreciated, the stored mass flow rate error values and/or the mass flow rate error correction relationship can be used to correct a measured mass flow rate value of a process gas measured by the vibratory meter. As the foregoing discussion illustrates the mass flow rate error values and/or the mass flow error correction relationship can be of a substitute gas and still be used to correct the measured mass flow rate of the process gas.

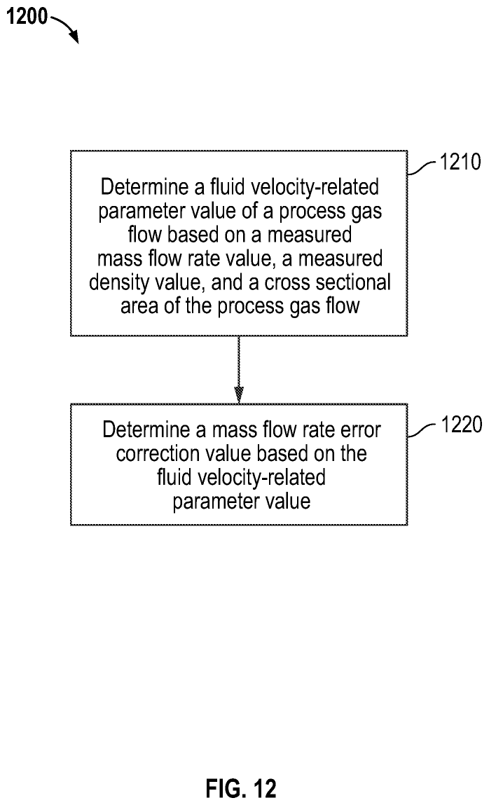

FIG. 12 shows a method 1200 of using a mass flow rate error correction relationship for a vibratory meter, such as the vibratory meter 5 described above. As shown in FIG. 12, the method 1200, in step 1210, determines a fluid velocity-related parameter value of a process gas flow based on a measured mass flow rate value, a density value, and a cross-sectional area of the process gas flow. In step 1220, the method 1200 determines a mass flow rate error correction value based on the fluid velocity-related parameter value.

As can be appreciated, the method 1200 may be performed by a suitable meter electronics of a vibratory meter, such as the meter electronics 20 of the vibratory meter 5 described above. By way of illustration with reference to FIGS. 1-3, the vibratory meter 5 comprises the storage system 304 and the processing system 302 communicatively coupled to the storage system 304. The processing system 302 may be configured to execute the method 1200. One or more of the values related to the process gas flow, such as the density or cross-sectional area of the process gas flow, for example, may be measured by the sensor assembly 10, input by a user, provided by another device, and/or the like.

In step 1220, determining the mass flow rate error correction value based on the fluid velocity-related parameter value may comprise obtaining the mass flow rate error correction relationship for a substitute gas flow and determining the mass flow rate correction value based on the mass flow rate error correction relationship for the substitute gas flow and the fluid velocity-related parameter value. The fluid velocity-related parameter value may comprise one of a fluid velocity value and a Mach number value of the process gas flow. As described above with reference to FIG. 11, the substitute gas flow may comprise one of air, natural gas, carbon dioxide, nitrogen, and helium. Because, as is explained above, the mass flow rate error correction relation can be transferred to other gases, the process gas flow can be a gas that has a different compressibility factor, such as a hydrogen gas flow.

The method 1200 may comprise additional steps. For example, the method 1200 may further measure, with the vibratory meter, a mass flow rate of the process gas flow to determine the measured mass flow rate value. Additionally, or alternatively, the method 1200 may correct the measured mass flow rate value with the mass flow rate error correction value.

The vibratory meter 5, meter electronics 20, system 1000, and methods 1100 and 1200 described above may determine and use a mass flow rate error correction relationship. For example, the method 1100 determines a mass flow rate error correction relationship based on a fluid velocity-related parameter of a substitute gas flow. Because the mass flow rate error correction relationship is based on the fluid velocity-related parameter, the mass flow rate measurement errors and, with more particularity, the mass flow rate error correction relationship, are transferable from the substitute gas flow to other gas flows. For example, non-linearities between different gas flows are at about the same Mach number but are typically not at about the same mass flow rate. This may be due to the compressibility of the various gases taken into account when Mach number is used. Accordingly, measured mass flow rates of a highly compressible gas, such as hydrogen, may be corrected based on mass flow rate measurement errors of a relatively less compressible, as well as more readily available and less expensive, such as air, carbon dioxide, or natural gas.

In addition, the vibratory meter 5 may be advantageously ranged due to the mass flow rate measurement errors that are based on fluid velocity-related parameters. For example, as discussed above, unacceptable signal noise in a vibratory meter, such as the vibratory meter 5 described above, is typically present at gas flow rates above 0.30 Mach. However, highly compressible gases tend to have relatively high speeds of sound. As a result, a given mass flow rate of highly compressible gas may have a lower Mach number than gases with more typical speeds of sound. Therefore, the vibratory meter 5 can measure a highly compressible gas at a relatively higher mass flow rate without experiencing signal noise. By way of illustration, the vibratory meter 5 can be rated to measure mass flow rates of hydrogen than at, for example, 3 times that of non-highly compressible gases.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other vibratory meters, meter electronics, and methods for determining and using a mass flow rate error correction relationship for a vibratory meter and not just to the embodiments described above and shown in the accompanying figures. Accordingly, the scope of the embodiments described above should be determined from the following claims.

We claim:

1. A method of determining a mass flow rate error correction value for a vibratory meter, the method comprising:
comparing each of a plurality of mass flow rate measurements of a substitute gas flow with a corresponding each of a plurality of reference mass flow rate measurements of the substitute gas flow; and
determining, based on the comparisons, a plurality of mass flow rate measurement errors corresponding to a plurality of fluid velocity-related parameter values of the substitute gas flow.

2. The method of claim 1, wherein the plurality of fluid velocity-related parameter values of the substitute gas flow comprises one of a plurality of fluid velocity values and a plurality of Mach number values of the substitute gas flow.

3. The method of claim 1, wherein the plurality of reference mass flow rate measurements of the substitute gas flow is provided by a reference device in line with the vibratory meter.

4. The method of claim 1, wherein the substitute gas flow comprises one of air, natural gas, carbon dioxide, nitrogen, and helium.

5. The method of claim 1, wherein the plurality of mass flow rate measurement errors corresponding to the plurality of fluid velocity-related parameter values of the substitute gas flow comprises a plurality of differences between the each of the plurality of mass flow rate measurement values and the corresponding each of the plurality of reference mass flow rate measurement values.

6. The method of claim 1, further comprising flowing the substitute gas flow through the vibratory meter.

7. The method of claim 1, further comprising determining, with the vibratory meter, the plurality of mass flow rate measurements at the corresponding plurality of fluid velocity-related parameter values of the substitute gas flow.

8. The method of claim 1, further comprising storing the plurality of the mass flow rate measurement errors in a meter electronics of the vibratory meter as a plurality of ordered pairs of the plurality of the mass flow rate measurement errors and the corresponding plurality of the fluid velocity-related parameter values.

9. The method of claim 1, further comprising determining a mass flow rate error correction relationship based on the plurality of mass flow rate measurement errors and the corresponding plurality of fluid velocity-related parameter values and storing the mass flow rate error correction relationship in the vibratory meter.

10. A system (1000) for determining a mass flow rate error correction relationship for a vibratory meter (5), the system (1000) comprising:
the vibratory meter (5) configured to measure a mass flow rate of a substitute gas flow;
a reference device (1010) in line with the vibratory meter (5), the reference device (1010) being configured to determine a reference mass flow rate of the substitute gas flow; and
a calibration circuit (1020) in communication with the vibratory meter (5) and the reference device (1010), the calibration circuit (1020) being configured to perform the method of claim 1.

11. A method for using a mass flow rate error correction relationship for a vibratory meter, the method comprising:
determining a fluid velocity-related parameter value of a process gas flow based on a measured mass flow rate value, a density value, and a cross-sectional area of the process gas flow; and
determining a mass flow rate error correction value based on the fluid velocity-related parameter value.

12. The method of claim 11, wherein the fluid velocity-related parameter value comprises one of a fluid velocity value and a Mach number value of the process gas flow.

13. The method of claim 11, wherein the process gas flow is a hydrogen gas flow.

14. The method of claim 11, further comprising measuring, with the vibratory meter, a mass flow rate of the process gas flow to determine the measured mass flow rate value.

15. The method of claim 11, further comprising correcting the measured mass flow rate value with the mass flow rate error correction value.

16. The method of claim 11, wherein determining the mass flow rate error correction value based on the fluid velocity-related parameter value comprises:
obtaining the mass flow rate error correction relationship for a substitute gas flow; and
determining the mass flow rate correction value based on the mass flow rate error correction relationship for the substitute gas flow and the fluid velocity-related parameter value.

17. The method of claim 16, wherein the substitute gas flow comprises one of air, natural gas, carbon dioxide, nitrogen, and helium.

18. A meter electronics (20) for using a mass flow rate error correction relationship, the meter electronics (20) comprising:
a storage system (304); and
a processing system (302) communicatively coupled to the storage system (304), the processing system (302) being configured to execute a method of claim 11.

19. A vibratory meter (5) for using a mass flow rate error correction relationship, the vibratory meter (5) comprising:
a sensor assembly (10) configured to measure a mass flow rate of a process gas flow; and
a meter electronics (20) communicatively coupled to the sensor assembly (10), the meter electronics (20) being provided according to the foregoing claim 18.
